(19) United States
(12) Patent Application Publication
(10) Pub. No.: US 2026/0091716 A1
(43) Pub. Date: Apr. 2, 2026

(54) SEATBACK AND METHOD OF MANUFACTURING THE SAME

(71) Applicant: TOYOTA BOSHOKU KABUSHIKI KAISHA, Aichi (JP)

(72) Inventors: Keisuke YAMAMOTO, Toyota-shi (JP); Ririka AKITA, Toyota-shi (JP); Yoshihiro MOTOI, Toyota-shi (JP)

(73) Assignee: TOYOTA BOSHOKU KABUSHIKI KAISHA, Aichi (JP)

(21) Appl. No.: 19/340,002

(22) Filed: Sep. 25, 2025

(30) Foreign Application Priority Data
Sep. 27, 2024 (JP) 2024-168583

(51) Int. Cl. B60N 2/68

(52) U.S. Cl. CPC B60N 2/682; B60N 2/686

(57) ABSTRACT

A seatback including a first seatback and a second seatback adjacent to the first seatback includes a first upper beam that is disposed on an upper end portion of the first seatback and that extends in seat width directions, and a second upper beam that is disposed on an upper end portion of the second seatback and that extends in the seat width directions. An end portion of the first upper beam on one end side in longitudinal directions thereof and an end portion of the second upper beam on an other end side in longitudinal directions thereof are joined together in a state where the end portion of the first upper beam on the one end side in the longitudinal directions thereof and the end portion of the second upper beam on the other end side in the longitudinal directions thereof overlap each other.

### CROSS-REFERENCE TO RELATED APPLICATIONS

This application claims the benefit of Japanese Patent Application No. 2024-168583 filed on Sep. 27, 2024 with the Japan Patent Office, the entire disclosure of which is incorporated herein by reference.

### BACKGROUND

The present disclosure relates to a seatback that includes a first seatback and a second seatback adjacent to the first seatback, and a method of manufacturing the seatback.

For example, a seatback disclosed in Japanese Unexamined Patent Application Publication No. 2008-194289 (hereinafter, also referred to as “Patent Document 1”) includes a first seatback and a second seatback adjacent to the first seatback. The first seatback includes a round pipe that is bent in a substantially inverted U-shape and pipes that extend in seat width directions to couple portions of the round pipe extending in up-down directions to each other, and the like.

The second seatback includes a round pipe that is bent in a substantially inverted L-shape and pipes that extend in the seat width directions to couple portions of the round pipes of the first seat back and the second seat back extending in the up-down directions to each other, and the like. The round pipe and the like of the second seat back are welded to the round pipe of the first seat back.

### SUMMARY

The present disclosure is one example of a seatback including a first seatback and a second seatback adjacent to the first seatback in which productivity can be improved.

In the seatback including the first seatback and the second seatback adjacent to the first seatback, it is desirable, for example, that the seatback comprises at least one of the following elements.

The elements are a first upper beam that is disposed on an upper end portion of the first seatback and that extends in seat width directions, the first upper beam being formed to have a substantially C-shaped cross-section or a substantially L-shaped cross-section, and a second upper beam that is disposed on an upper end portion of the second seatback and that extends in the seat width directions, the second upper beam being formed to have a substantially C-shaped cross-section or a substantially L-shaped cross-section.

It is desirable that an end portion of the first upper beam on one end side in longitudinal directions of the first upper beam and an end portion of the second upper beam on an other end side in longitudinal directions of the second upper beam are joined together in a state where the end portion of the first upper beam on the one end side in the longitudinal directions of the first upper beam and the end portion of the second upper beam on the other end side in the longitudinal directions of the second upper beam overlap each other.

Therefore, in manufacturing of the seatback, for example, it is possible to attach the second seatback to the first seatback from a front of the first seatback in a state where the first seatback is held in place, and then join the end portion of the first upper beam on the one end side in the longitudinal directions of the first upper beam and the end portion of the second upper beam on the other end side in the longitudinal directions of the second upper beam together.

Consequently, it may be possible to reduce manufacturing workload of the seatback while facilitating maintenance of joint quality of joint portions obtained by welding and the like. Furthermore, manufacturing methods similar to that of the seatback can be easily applied to seatbacks with various specifications such as different sizes.

The seatback may have, for example, the following configurations. It is desirable that the seatback further comprises a side frame that is disposed on one end side of the first seatback in the seat width directions and that extends in up-down directions, the side frame being joined to the end portion of the first upper beam on the one end side in the longitudinal directions of the first upper beam, a lower beam that is disposed below the second upper beam within the second seatback and that extends in the seat width directions, the lower beam being formed to have a substantially C-shaped cross-section, and a panel member to which the second upper beam and the lower beam are joined, and an end portion of the lower beam on an other end side in longitudinal directions of the lower beam is joined to a side surface of the side frame.

### BRIEF DESCRIPTION OF THE DRAWINGS

An example embodiment of the present disclosure will be described hereinafter with reference to the accompanying drawings, in which:

FIG. 1 shows a seatback according to a first embodiment;

FIG. 2 shows a structure of a first seatback according to the first embodiment;

FIG. 3 shows a first upper beam according to the first embodiment;

FIG. 4 shows a coupling structure between the first seatback and a second seatback according to the first embodiment;

FIG. 5 shows a structure of the second seatback according to the first embodiment;

FIG. 6 shows a second upper beam according to the first embodiment; and

FIG. 7 shows the second seatback according to the first embodiment.

### DETAILED DESCRIPTION OF EXEMPLARY EMBODIMENTS

An embodiment described hereinafter is one example of embodiments that fall within the technical scope of the present disclosure. In other words, matters specifying the invention recited in claims are not limited to specific configurations, structures, and the like that are described in the following embodiment.

The present embodiment is one example in which a seatback according to the present disclosure is applied to a seat to be mounted in a vehicle such as an automobile (hereinafter, referred to as “vehicle seat”). Arrows indicating directions and the like shown in the drawings are provided to facilitate understanding of mutual relationships between the drawings, shapes of members or portions, and the like.

Thus, an orientation of the seatback is not limited to those shown in the drawings. The directions shown in the drawings indicate an orientation of the seatback of the present embodiment in a state where the seatback is mounted in an automobile.

A member or a portion described at least with a reference numeral is at least one in number except in a case of being accompanied by a restrictive term such as “only one of”. In other words, the member or the portion may be two or more in number in a case of not being accompanied by the restrictive term such as “only one of”. The seatback disclosed in the present disclosure includes at least one of an element such as the member or the portion described at least with a reference numeral or a structural portion shown in the drawings.

### First Embodiment

### <1. Outline of Seatback>

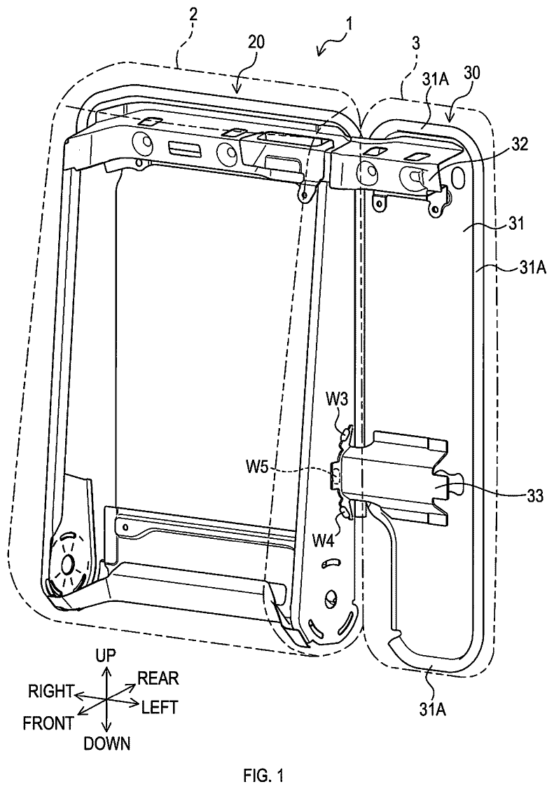

The present embodiment is one example of the seatback to be used for rear seats of an automobile. Specifically, as shown in FIG. 1, a seatback 1 includes a first seatback 2, a second seatback 3, and the like.

The seatback 1 supports the back of an occupant. The second seatback 3 is arranged to be displaced from the first seatback 2 in seat width directions and is adjacent to the first seatback 2.

Among rear seats on which three passengers can be seated, the first seatback 2 is to be used for a seat on a right side of the vehicle, and the second seatback 3 is to be used for a center seat. Each of the first seatback 2 and the second seatback 3 includes a back frame, a cushion member such as a pad, a surface cover portion, and the like.

### <2. Detail of Seatback>

### <2.1 Back Frame of First Seatback>

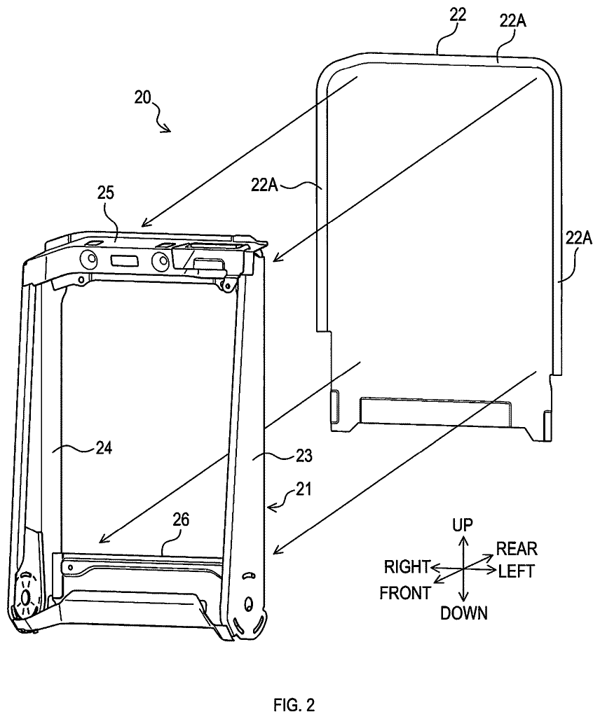

As shown in FIG. 2, a back frame 20 of the first seatback 2 includes a frame body 21, a back panel 22, and the like. The frame body 21 is formed in a rectangular frame shape. Specifically, the frame body 21 includes at least a first side frame 23, a second side frame 24, an upper beam 25, a lower beam 26, and the like.

The first side frame 23 is a strength member that is disposed on one end side (in the present embodiment, left end side) in the seat width directions and that extends in up-down directions. The second side frame 24 is a strength member that is disposed on the other end side (in the present embodiment, right end side) in the seat width directions and that extends in the up-down directions.

The upper beam 25 is a member that extends in the seat width directions to couple an upper end portion of the first side frame 23 and an upper end portion of the second side frame 24 to each other. The upper beam 25 is formed to have a substantially C-shaped cross-section (in the present embodiment, a substantially C-shaped cross-section having corners) or a substantially L-shaped cross-section, with an opening oriented rearward.

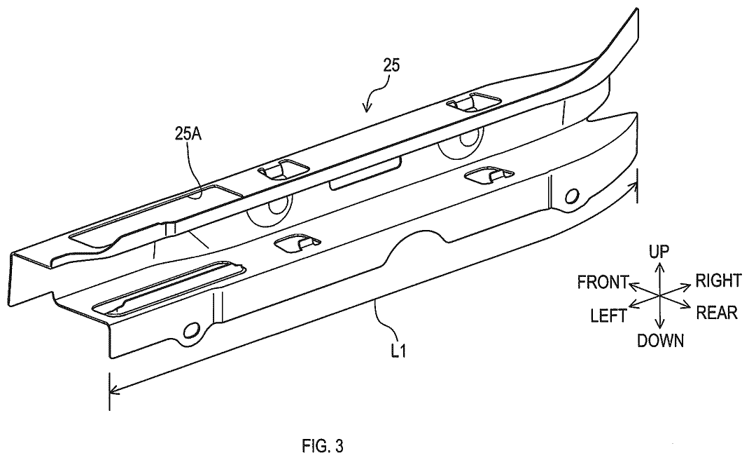

In the present embodiment, as shown in FIG. 3, a region L1 of the upper beam 25, which is located between the first side frame 23 and an end portion of the upper beam 25 on a second side frame 24 side (in FIG. 3, a right end portion of the upper beam 25) has a substantially C-shaped cross-section (in the present embodiment, a substantially C-shaped cross-section having corners).

An end portion of the upper beam 25 on a first side frame 23 side (in FIG. 3, a left end portion of the upper beam 25) is formed to have an L-shaped cross-section to include an upper surface portion and a front surface portion. It should be noted that the upper beam 25 is obtained by performing press working on a steel plate so that the upper beam 25 has a substantially C-shaped cross-section (in the present embodiment, a substantially C-shaped cross-section having corners) or a substantially L-shaped cross-section.

The upper beam 25 includes a belt receiving portion 25A. The belt receiving portion 25A is a portion of the upper beam 25 where a through hole for inserting a seat belt (not shown) is formed. In a case where tension is generated in the seat belt, the tension acts on the belt receiving portion 25A.

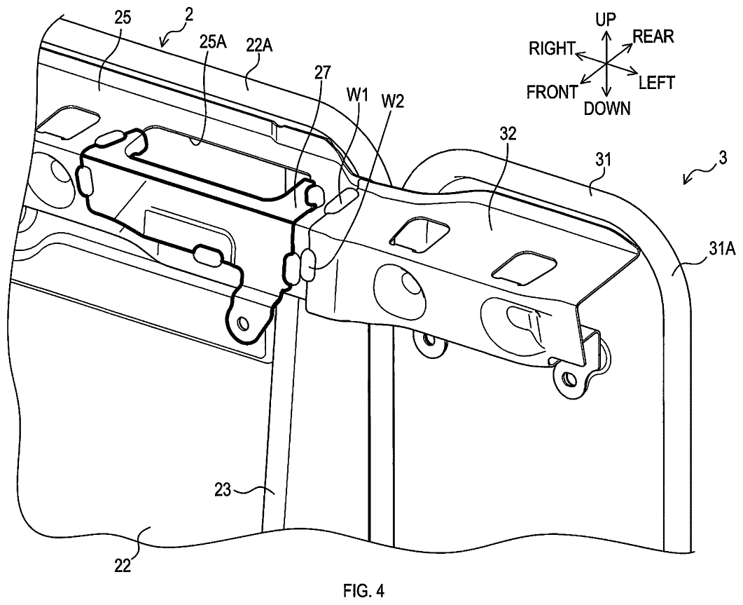

Therefore, as shown in FIG. 4, a reinforcing patch 27, which is indicated in a thick solid line, is provided on at least a front portion of a peripheral region of the belt receiving portion 25A. The reinforcing patch 27 is joined to the upper beam 25 by welding or the like to cover the front portion of the peripheral region of the belt receiving portion 25A and a part of the front surface portion of the upper beam 25.

As shown in FIG. 2, the lower beam 26 extends in the seat width directions to couple a lower end portion of the first side frame 23 and a lower end portion of the second side frame 24 to each other. The lower beam 26 according to the present embodiment includes a panel member that is formed to have a substantially C-shaped cross-section with an opening oriented upward.

The back panel 22 is a plate-shaped member made of metal. The back panel 22 is disposed behind the frame body 21 to cover the entire rear surface of the frame body 21. A peripheral region of the back panel 22 other than a lower peripheral region includes a curled portion 22A.

The curled portion 22A is curved in a circular arc shape. The curled portion 22A is an integrated portion formed integrally with the back panel 22 by performing plastic working on the peripheral region of the back panel 22 having a plate shape. The first side frame 23, the second side frame 24, the upper beam 25, the lower beam 26, and the back panel 22 are joined together by welding.

### <2.2 Back Frame of Second Seatback>

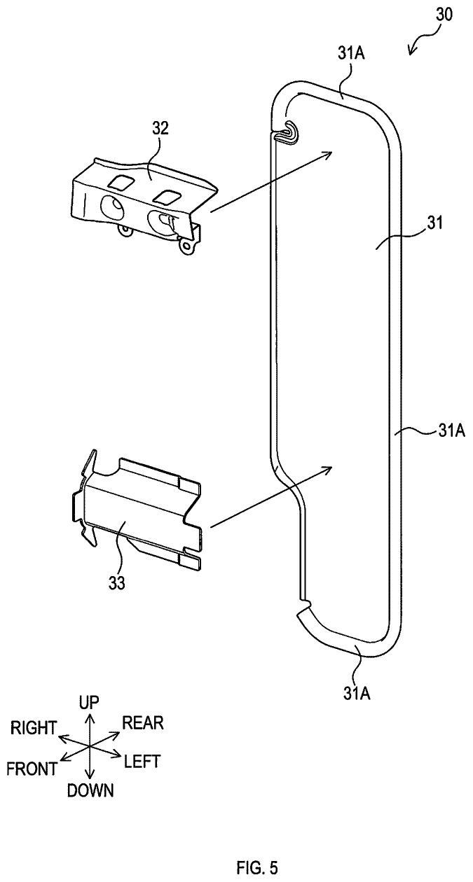

As shown in FIG. 5, a back frame 30 of the second seatback 3 includes a back panel 31, an upper beam 32, a lower beam 33, a side frame (not shown), and the like.

The back panel 31 is a plate-shaped member made of metal or resin and is one example of a panel member to which the upper beam 32 and the lower beam 33 are coupled. In the present embodiment, the back panel 31, the upper beam 32, the lower beam 33, and the side frame are made of metal. The upper beam 32, the lower beam 33, and the side frame are joined to a front surface of the back panel 31 by welding.

A peripheral region of the back panel 31 other than a peripheral region on a first seatback 2 side includes a curled portion 31A. The curled portion 31A is curved in a circular arc shape, and is an integrated portion formed integrally with the back panel 31 by performing plastic working on the peripheral region of the back panel 31 having a plate-shape.

The upper beam 32 is, as shown in FIG. 1, a member that is disposed on an upper end portion of the back panel 31 and that extends in the seat width directions. The upper beam 32 is formed to have a substantially C-shaped cross-section (in the present embodiment, a substantially C-shaped cross-section having corners) or a substantially L-shaped cross-section, with an opening oriented rearward.

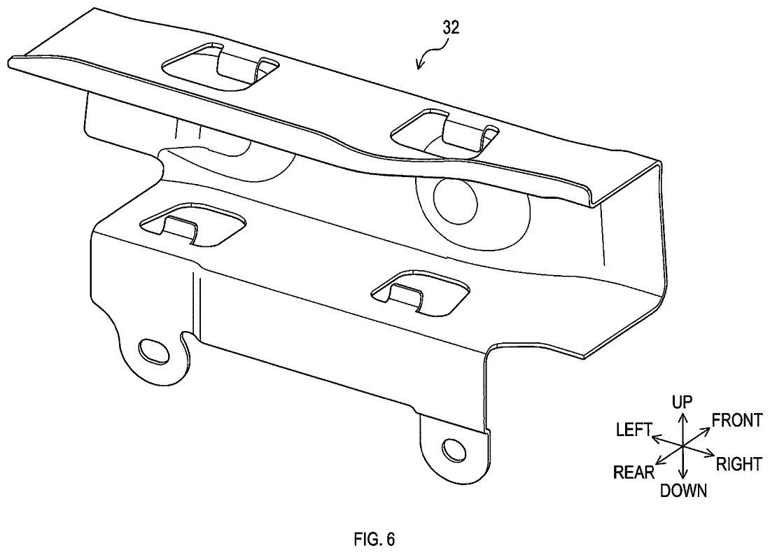

It should be noted that, in the present embodiment, as shown in FIG. 6, a specific region of the upper beam 32 from its end portion on the first seatback 2 side (in FIG. 6, a right end portion of the upper beam 32), has a substantially C-shaped cross-section (in the present embodiment, a substantially C-shaped cross-section having corners). An end portion of the upper beam 32 opposite to the end portion on the first seatback 2 side (in FIG. 6, a left end portion of the upper beam 32) is formed to have an L-shaped cross-section to include an upper surface portion and a front surface portion.

The lower beam 33 is, as shown in FIG. 1, a member that is disposed below the upper beam 32 within the back panel 31 and that extends in the seat width directions. The lower beam 33 is formed to have a substantially C-shaped cross-section with an opening oriented rearward.

The side frame is a member that is disposed on a side opposite to the first seatback 2 with respect to the upper beam 32 and the lower beam 33, and that extends in the up-down directions. The side frame is joined, by welding, to an end portion of the upper beam 32 and an end portion of the lower beam 33 located on one end side (in the present embodiment, left end side) in longitudinal directions of the upper beam 32 and the lower beam 33, respectively.

### <2.3 Coupling Structure Between First Seatback and Second Seatback>

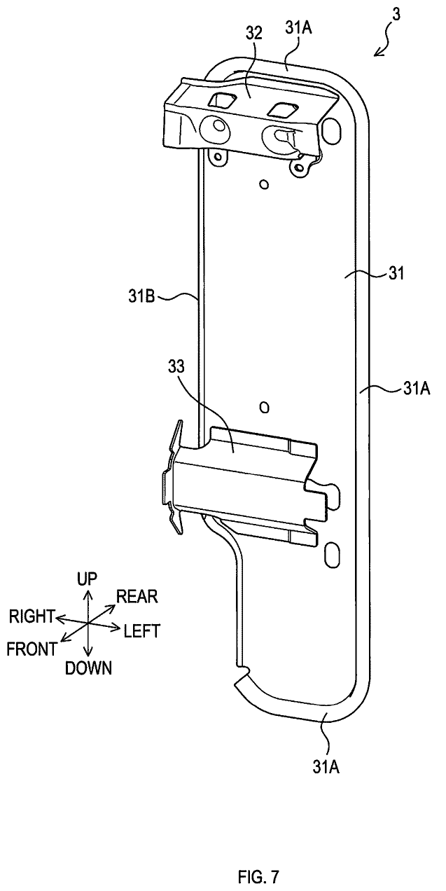

In the second seatback 3, an end portion of the upper beam 32 (hereinafter, referred to as “second upper beam 32”) and an end portion of the lower beam 33 that are located on the first seatback 2 side project from an edge 31B of the back panel 31 toward the first seatback 2 side (in the present embodiment, the right side), as shown in FIG. 7.

As shown in FIG. 4, an end portion of the upper beam 25 (hereinafter, referred to as “first upper beam 25”), of the first seatback 2, on one end side in longitudinal directions of the first upper beam 25 and an end portion of the second upper beam 32 on the other end side in longitudinal directions of the second upper beam 32 are joined together by welding in a state where the end portion of the upper beam 25 on the one end side in the longitudinal directions of the first upper beam 25 and the end portion of the second upper beam 32 on the other end side in the longitudinal directions of the second upper beam 32 overlap each other.

Specifically, the right end portion of the second upper beam 32 and the left end portion of the first upper beam 25 are joined together by arc welding in a state where the right end portion of the second upper beam 32 is placed on the left end portion of the first upper beam 25 to cover the left end portion of the first upper beam 25 from its outside. Reference numerals W1 and W2 indicate weld beads formed by the arc welding.

As shown in FIG. 1, an end portion of the lower beam 33 on the other end side (in the present embodiment, right end side) in longitudinal directions of the lower beam 33 is joined, by arc welding, to a side surface of the first side frame 23. In joint portions W3, W4, the welding is performed from a side where the second seatback 3 is located, whereas in a joint portion W5, the welding is performed from a side where the first seatback 2 is located.

### <2.4 Outline of Method of Manufacturing Seatback>

Each of the first seatback 2 and the second seatback 3 is manufactured independently. Among a manufacturing process of the seatback 1, in coupling of the first seatback 2 and the second seatback 3, an assembly robot (not shown) attaches the second seatback 3 to the first seatback 2 from the front of the first seatback 2 in a state where the first seatback 2 is held in place by a jig (not shown).

As a result, the right end portion of the second upper beam 32 is placed on the left end portion of the first upper beam 25 to cover the left end portion of the first upper beam 25 from outside. Then, a welding robot or a welding operator joins the right end portion of the second upper beam 32 and the left end portion of the first upper beam 25 together by arc welding.

It should be noted that, in the present embodiment, the first seatback 2 is held in place because a mass and an outer dimension of the first seatback 2 are greater than a mass and an outer dimension of the second seatback 3. In a case where the mass and the outer dimension of the second seatback 3 are greater than the mass and the outer dimension of the first seatback 2, the second seatback 3 is held in place.

That is, among the first seatback 2 and the second seatback 3, “a seat back having a greater mass or a greater outer dimension” is held in place, and “a seat back having a smaller mass or a smaller outer dimension” is attached to “the seat back having the greater mass or the greater outer dimension” by the assembly robot.

Furthermore, in the present embodiment, the second seatback 3 is attached to the first seatback 2 from the front of the first seatback 2 because an outer dimension of the back panel 22 is greater than an outer dimension of the frame body 21. In a case where the outer dimension of the frame body 21 is greater than the outer dimension of the back panel 22, the first seatback 2 may be attached to the second seatback 3 from a rear side.

### <3. Features of Seatback of Present Embodiment and Method of Manufacturing Seatback>

In the seatback 1 according to the present embodiment, the left end portion of the first upper beam 25 of the first seatback 2 and the right end portion of the second upper beam 32 of the second seatback 3 are joined together in a state where the left end portion of the first upper beam 25 and the right end portion of the second upper beam 32 overlap each other.

Therefore, in manufacturing of the seatback 1, it is possible to attach the second seatback 3 to the first seatback 2 from the front of the first seatback 2 in a state where the first seatback 2 is held in place, and then join the left end portion of the first upper beam 25 and the right end portion of the second upper beam 32 together, as described above.

Consequently, it may be possible to reduce manufacturing workload of the seatback while facilitating maintenance of joint quality of the joint portions obtained by welding and the like. Furthermore, in the seatback, since similar manufacturing methods can be applied also to seatbacks with various specifications such as different sizes, it may be possible to reduce manufacturing workload and manufacturing costs also for such seatbacks.

It should be noted that, in the invention described in Patent Document 1, the pipe materials are welded to each other in a state where the pipe materials are assembled from two or more directions. Therefore, it is difficult to maintain joint quality of welded portions and to reduce manufacturing workload (particularly, assembling workload).

As contrasted thereto, in the seatback 1 according to the present embodiment, the left end portion of the first upper beam 25 and the right end portion of the second upper beam 32 are placed on and welded to each other after the first seatback 2 and the second seatback 3 are individually manufactured. Therefore, it may be possible to reduce the manufacturing workload while facilitating maintenance of joint quality.

### Other Embodiments

In the above-described embodiment, the first upper beam 25 and the second upper beam 32 are joined by arc welding. However, the present disclosure is not limited thereto. The present disclosure may have a configuration in which the first upper beam 25 and the second upper beam 32 are joined by an adhesive.

In the above-described embodiment, the right end portion of the second upper beam 32 and the left end portion of the first upper beam 25 are joined together in a state where the right end portion of the second upper beam 32 is placed on the left end portion of the first upper beam 25 to cover the left end portion of the first upper beam 25 from outside. However, the present disclosure is not limited thereto.

The present disclosure may have a configuration in which, for example, the first upper beam 25 and the second upper beam 32 are joined together in a state where the left end portion of the first upper beam 25 is placed on the right end portion of the second upper beam 32 to cover the right end portion of the second upper beam 32 from outside.

In the above-described embodiments, the seatback according to the present disclosure is applied to an automobile. However, application of the present disclosure is not limited thereto. The present disclosure may be applied, for example, to seats for use in various vehicles including railroad vehicles, ships and air crafts, as well as stationary seats for use in theaters, homes, and other places.

Furthermore, the present disclosure is not limited to the above-described embodiments as long as it falls within the gist of the disclosure described in the above-described embodiments. Therefore, a configuration may be employed in which at least two embodiments among the above-described embodiments are combined, or in which any element shown in the drawings or described with reference numeral is omitted in the above-described embodiments.

What is claimed is:

1. A seatback including a first seatback and a second seatback adjacent to the first seatback,
the seatback comprising:
a first upper beam that is disposed on an upper end portion of the first seatback and that extends in seat width directions, the first upper beam being formed to have a substantially C-shaped cross-section or a substantially L-shaped cross-section; and
a second upper beam that is disposed on an upper end portion of the second seatback and that extends in the seat width directions, the second upper beam being formed to have a substantially C-shaped cross-section or a substantially L-shaped cross-section,
an end portion of the first upper beam on one end side in longitudinal directions of the first upper beam and an end portion of the second upper beam on an other end side in longitudinal directions of the second upper beam being joined together in a state where the end portion of the first upper beam on the one end side in the longitudinal directions of the first upper beam and the end portion of the second upper beam on the other end side in the longitudinal directions of the second upper beam overlap each other.

2. The seatback according to claim 1,
the seatback further comprising:
a side frame that is disposed on one end side of the first seatback in the seat width directions and that extends in up-down directions, the side frame being joined to the end portion of the first upper beam on the one end side in the longitudinal directions of the first upper beam;
a lower beam that is disposed below the second upper beam within the second seatback and that extends in the seat width directions, the lower beam being formed to have a substantially C-shaped cross-section; and
a panel member to which the second upper beam and the lower beam are joined,
wherein an end portion of the lower beam on an other end side in longitudinal directions of the lower beam is joined to a side surface of the side frame.

3. A method of manufacturing a seatback,
the seat back including:
a first seatback;
a second seatback adjacent to the first seatback;
a first upper beam that is disposed on an upper end portion of the first seatback and that extends in seat width directions, the first upper beam being formed to have a substantially C-shaped cross-section or a substantially L-shaped cross-section; and
a second upper beam that is disposed on an upper end portion of the second seatback and that extends in the seat width directions, the second upper beam being formed to have a substantially C-shaped cross-section or a substantially L-shaped cross-section, and
an end portion of the first upper beam on one end side in longitudinal directions of the first upper beam and an end portion of the second upper beam on an other end side in longitudinal directions of the second upper beam being joined together in a state where the end portion of the first upper beam on the one end side in the longitudinal directions of the first upper beam and the end portion of the second upper beam on the other end side in the longitudinal directions of the second upper beam overlap each other,
the method comprising attaching the second seatback to the first seatback from a front of the first seatback in a state where the first seatback is held in place, and then joining the end portion of the first upper beam on the one end side in the longitudinal directions of the first upper beam and the end portion of the second upper beam on the other end side in the longitudinal directions of the second upper beam together.
